(19) United States
(12) Patent Application Publication
(10) Pub. No.: US 2013/0017734 A1
(43) Pub. Date: Jan. 17, 2013

(54) CONNECTOR

(71) Applicants: Toshio Masumoto, Tokyo (JP); Takamitsu Wada, Tokyo (JP); Kenichi Kotaka, Tokyo (JP); Tadahiro Ota, Tokyo (JP)

(72) Inventors: Toshio Masumoto, Tokyo (JP); Takamitsu Wada, Tokyo (JP); Kenichi Kotaka, Tokyo (JP); Tadahiro Ota, Tokyo (JP)

(73) Assignee: Japan Aviation Electronics Industry, Ltd., Tokyo (JP)

(21) Appl. No.: 13/521,634

(22) PCT Filed: Nov. 30, 2010
(86) PCT No.: PCT/JP2010/006975

§ 371 Date: Jul. 11, 2012

(30) Foreign Application Priority Data
Mar. 19, 2010 (JP) 2010-064504

(51) Int. Cl. H01R 24/64

(52) U.S. Cl. 439/676

(57) ABSTRACT

A shell of a modular jack includes soldered terminal portions connected to a substrate. The soldered terminal portions include first soldered terminal portions and second soldered terminal portions. The first soldered terminal portions are formed to extend toward the substrate from first side wall portions folded from a front surface of the housing toward a right-side surface and a left-side surface. The second soldered terminal portions are formed to extend toward the substrate from second side wall portions folded from an upper wall portion toward the right-side surface and the left-side surface of the housing, the upper wall portion being folded from the front surface of the housing toward a top surface. The first side wall portions and the second side wall portions cover the right-side surface and the left-side surface of the housing.

### TECHNICAL FIELD

The present invention relates to a connector.

### BACKGROUND ART

As a technique of this type, Patent Literature 1 discloses a USB (Universal Serial Bus) connector 20 of a so-called right angle type as shown in FIGS. 14 and 15 of this application. This USB connector 20 includes a metal plate shell formed by folding a metal plate. As shown in FIG. 15, this metal plate shell 23 includes a top plate portion 31, right and left side surface plate portions 32 and 33, and a base plate portion 34. A locking piece 36 extending from the base plate portion 34 locks the outer surface of the right-side surface plate portion 33.

### CITATION LIST

### Patent Literature

Japanese Unexamined Patent Application Publication No. 2000-357550

### SUMMARY OF INVENTION

### Technical Problem

The connector disclosed in Patent Literature 1 still has room for improvement in suppression of material cost.

It is an object of the present invention to provide a connector that achieves suppression of material cost.

### Solution to Problem

According to an aspect of the present invention, there is provided a connector of a right angle type used to be mounted on a substrate, the connector including: a contact; a housing that holds the contact; and a shell that covers the housing. The connector has the following structure. That is, the shell includes a soldered terminal portion connected to the substrate. The soldered terminal portion includes a first soldered terminal portion and a second soldered terminal portion. The first soldered terminal portion is formed to extend toward the substrate from a first side wall portion folded from a front surface of the housing toward a side surface of the housing, the housing having a coupling hole into which a counterpart connector is inserted. The second soldered terminal portion is formed to extend toward the substrate from a second side wall portion folded from an upper wall portion toward the side surface of the housing, the upper wall portion being folded from the front surface of the housing toward a top surface of the housing. The first side wall portion and the second side wall portion cover the side surface of the housing.

The connector described above also has the following structure. That is, the shell includes a front wall portion provided on the front surface of the housing.

The connector described above also has the following structure. That is, the shell includes an abutting portion formed to be able to abut the substrate when a torque that keeps the second side wall portion away from the substrate acts on the housing.

The connector described above also has the following structure. That is, the abutting portion is formed to be folded from the front surface of the housing toward the side surface.

The connector described above has the following structure. That is, the housing is formed to be able to abut the substrate when a torque that keeps the second side wall portion away from the substrate acts on the housing.

The connector described above also has the following structure. That is, the back surface of the housing is formed to be able to abut the substrate when a torque that keeps the second side wall portion away from the substrate acts on the housing.

### Advantageous Effects of Invention

According to the present invention, it is possible to provide a connector having no overlapping portion between the first side wall portion including the first soldered terminal portion and the second side wall portion including the second soldered terminal portion, the first side wall portion and the second side wall portion covering the side surface of the housing, thereby achieving suppression of material cost.

### BRIEF DESCRIPTION OF DRAWINGS

FIG. 1 is a perspective view of a modular connector according to a first embodiment of the present invention;

FIG. 2 is a side view of the modular connector according to the first embodiment of the present invention;

FIG. 3 is a perspective view of the modular jack according to the first embodiment of the present invention when viewed from the front side;

FIG. 4 is a perspective view of the modular jack according to the first embodiment of the present invention when viewed from the back side;

FIG. 5 is a perspective view of a housing that holds a plurality of contacts;

FIG. 6 is a perspective view of a shell;

FIG. 7 is a perspective view of a substrate;

FIG. 8 is a development view of the shell;

FIG. 9 is a side view of the modular connector according to the first embodiment of the present invention;

FIG. 10A is a partial enlarged view of FIG. 9;

FIG. 10B is a partial enlarged view of FIG. 9;

FIG. 11 is a schematic sectional view taken along the line XI-XI- of FIG. 1;

FIG. 12 is a perspective view of a modular connector using a modular jack according to a second embodiment of the present invention;

FIG. 13 is a perspective view of a module jack according to a third embodiment of the present invention when viewed from the back side;

FIG. 14 corresponds to FIG. 2 of Patent Literature 1; and

FIG. 15 corresponds to FIG. 3 of Patent Literature 1.

### DESCRIPTION OF EMBODIMENTS

### First Embodiment

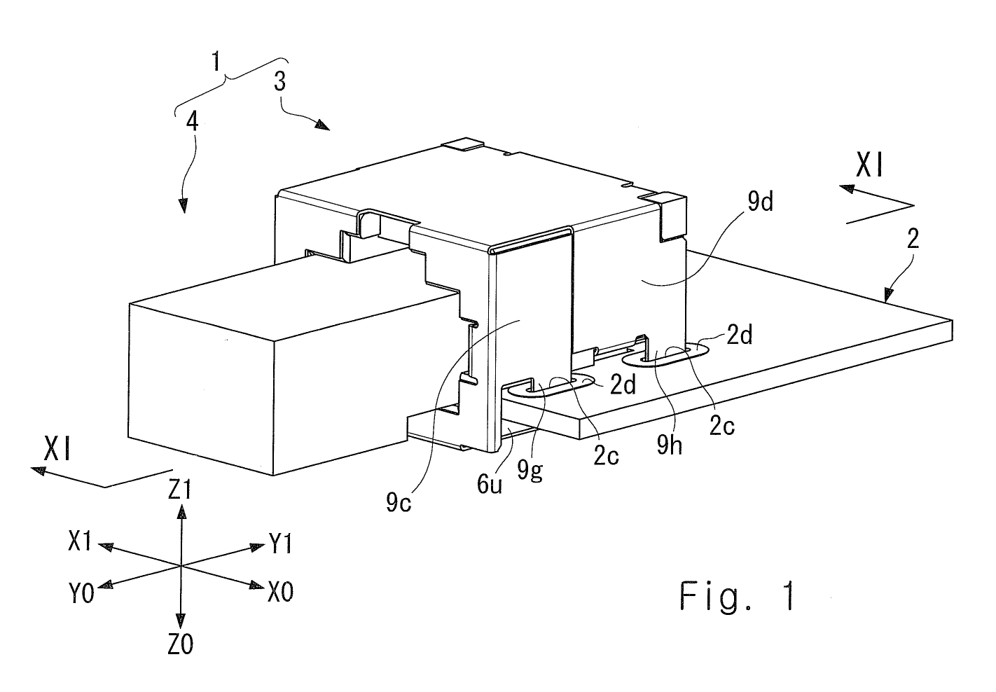

Hereinafter, a modular jack according to a first embodiment of the present invention will be described with reference to FIGS. 1 to 11.

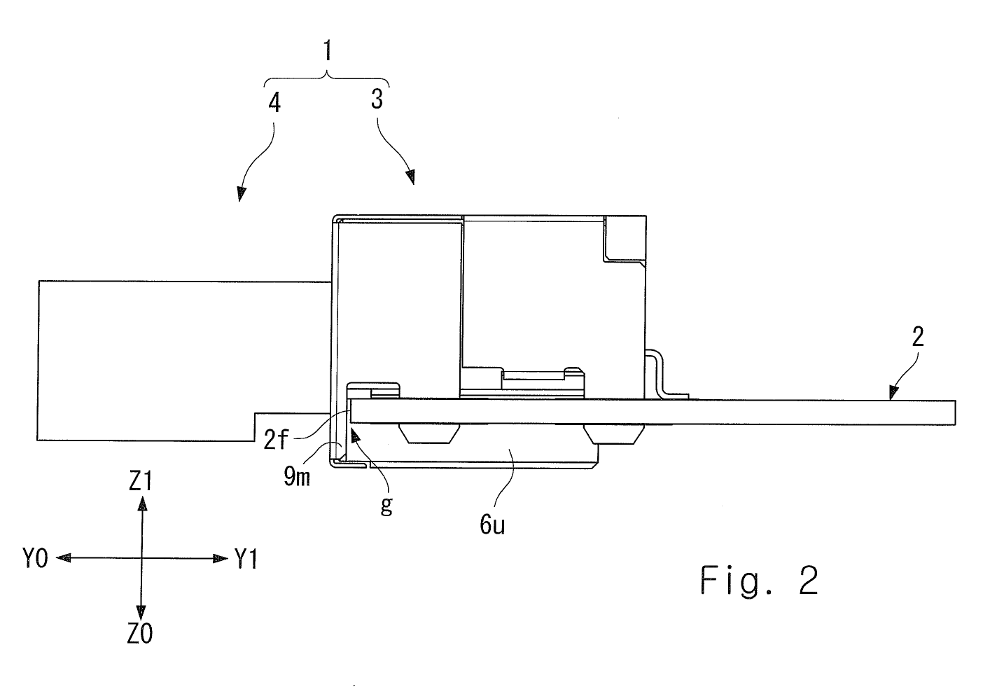

First, FIGS. 1 and 2 show a modular connector 1 and a substrate 2. The modular connector 1 connects a cable, such as a LAN (Local Area Network) cable, to the substrate 2, and is composed of a modular jack 3 (connector) which is mounted on the substrate 2, and a modular plug 4 (counterpart connector) which is mounted to the cable. The modular plug 4 is coupled with the modular jack 3, thereby allowing the cable to be connected to the substrate 2.

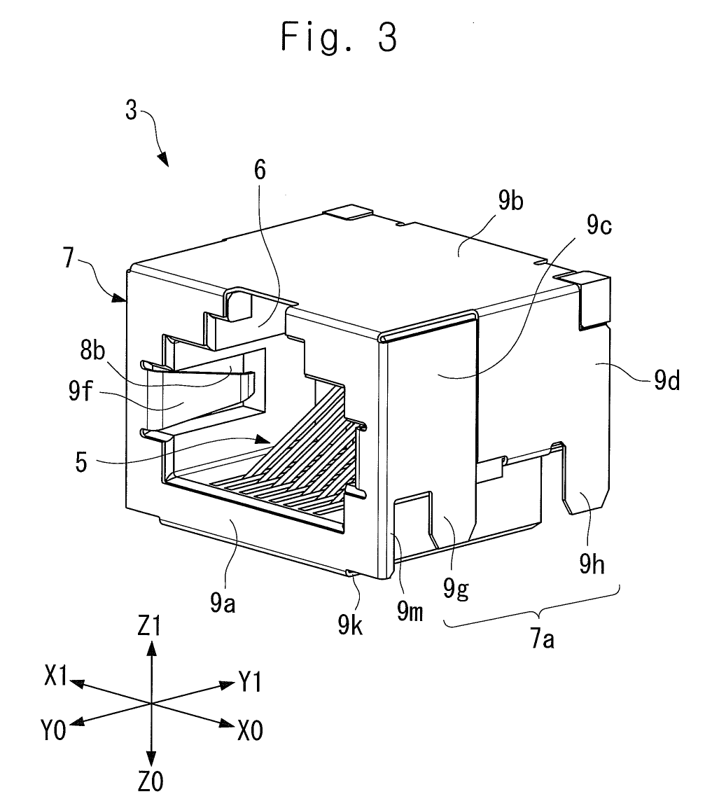

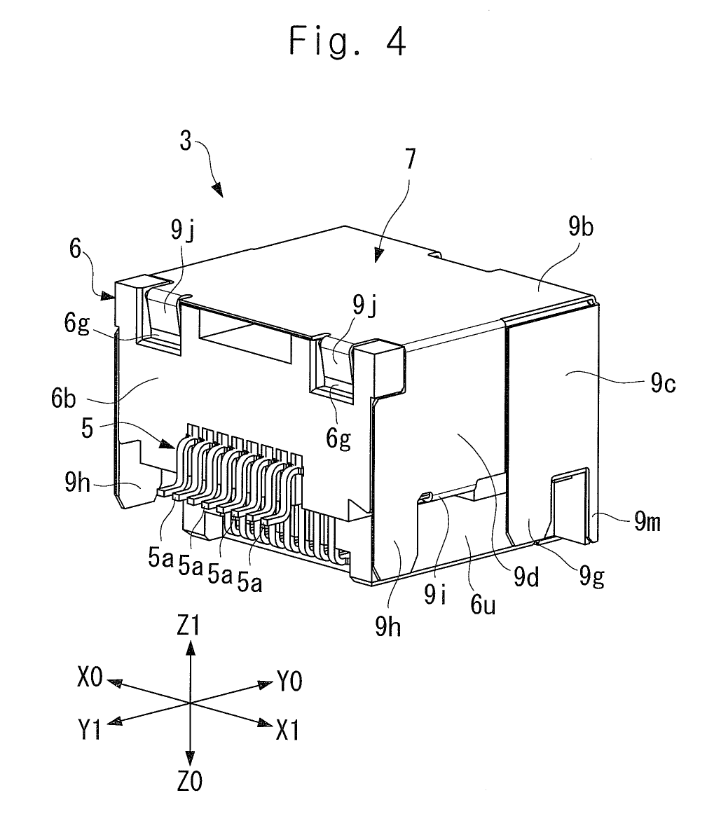

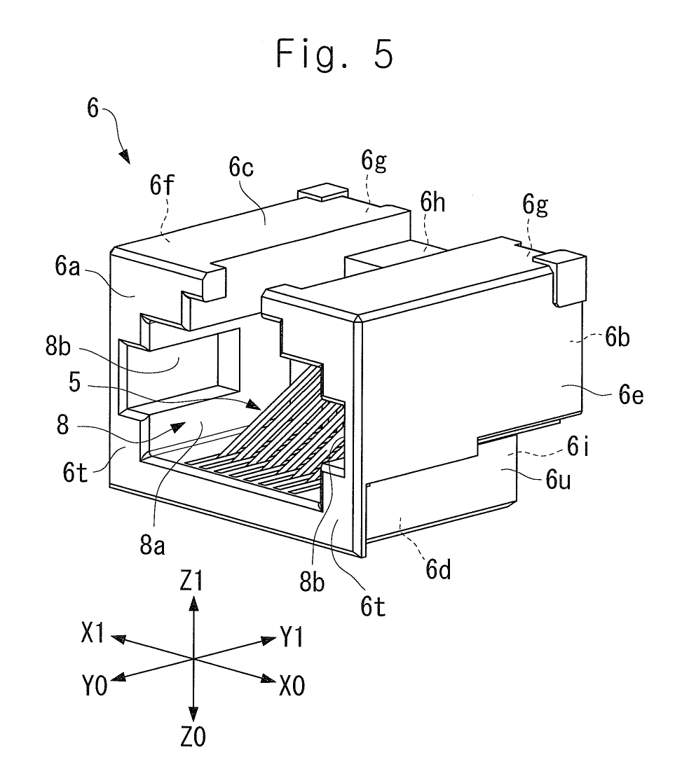

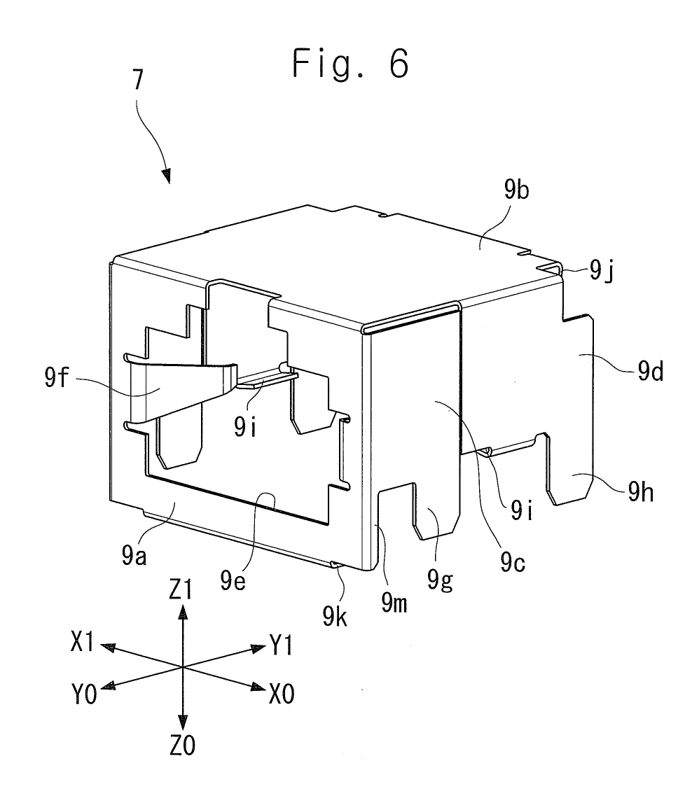

FIGS. 3 and 4 show the modular jack 3 described above. The modular jack 3 includes a plurality of contacts 5, a housing 6 (also see FIG. 5) that holds the plurality of contacts 5, and a shell 7 (also see FIG. 6) that covers the housing 6. As shown in FIGS. 1 and 2, the modular jack 3 is used to be mounted on the substrate 2, and is formed as a right angle type (a type in which a female connector and a male connector are coupled to the substrate is the horizontal direction and a terminal portion to be mounted on the substrate is bent toward the substrate) as shown in the figures.

Herein, for convenience of explanation, as shown in FIG. 1, the direction in which the modular plug 4 is inserted into the modular jack 3 is defined as a direction Y1, and the direction opposite to the direction Y1 is defined as a direction Y0. Similarly, as shown in FIG. 1, the directions which are orthogonal to the directions Y1 and Y0 and parallel with the plane direction of the principal surface of the substrate 2 are defined as directions X0 and X1. Further, as shown in FIG. 1, the directions which are orthogonal to the directions Y1 and Y0 and the directions X0 and X1, that is, the normal line directions of the principal surface of the substrate 2 are defined as directions Z0 and Z1.

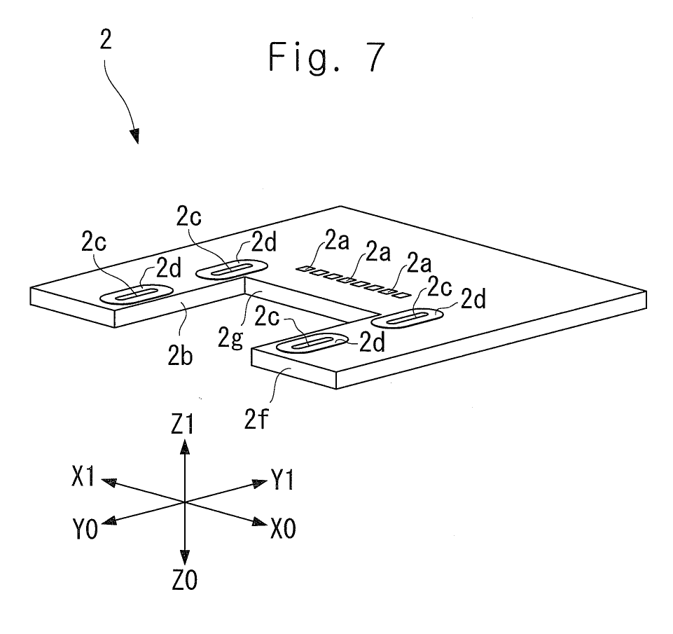

As shown in FIG. 5, the housing 6 has a substantially cubic shape and includes a front surface 6a, a back surface 6b, a top surface 6c, a bottom surface 6b, a right-side surface 6e, and a left-side surface 6f. A coupling chamber 8 (coupling hole) into which the modular plug 4 (also see FIG. 1) can be inserted is formed in the front surface 6a of the housing 6. As shown in FIGS. 3 and 4, the plurality of contacts 5 held by the housing 6 is formed to penetrate through the back surface 6b from the inside of the coupling chamber 8 and project from the housing 6. Substrate-side edges 5a of the contacts 5 shown in FIG. 4 are respectively soldered to electrode pads 2a of the substrate 2 shown in FIG. 7. In this regard, it can be said that the modular jack 3 of this embodiment is a surface mount type modular jack.

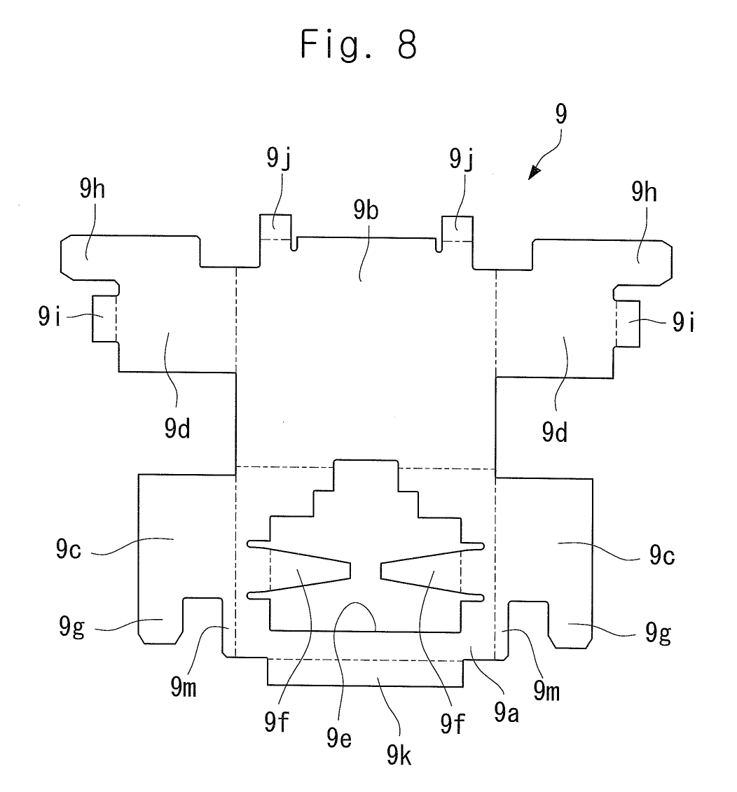

The shell 7 shown in FIG. 6 covers the housing 6 as shown in FIGS. 3 and 4 for countermeasures against EMI (Electromagnetic Interference), and is formed by performing a folding process as shown in FIG. 6 on a metal plate 9 shown in FIG. 8.

As shown in FIGS. 1 and 2, the substrate 2 shown in FIG. 7 includes a notch 2b having a substantially rectangular shape in plan view for housing a part of the modular jack 3; fixing holes 2c for fixing the modular jack 3 to the substrate 2; and the electrode pads 2a described above. As shown in FIG. 7, the plurality of fixing holes 2c is formed to sandwich the notch 2b in the directions X0 and X1. Specifically, two fixing holes 2c are formed on the side of the direction X0 when viewed from the notch 2b of the substrate 2, and similarly, two fixing holes 2c are formed on the side of the direction X1. Copper foils 2d are attached around the respective fixing holes 2c.

Next, the housing 6 shown in FIG. 5 and the shell 7 shown in FIG. 6 will be described in more detail.

### (Housing 6)

A substrate inserting portion 6u having a slightly narrow width is formed at a lower portion of the housing 6. As shown in FIGS. 1 and 2, the substrate inserting portion 6u is inserted into the notch 2b (also see FIG. 7) of the substrate 2. Further, as shown in FIG. 5, while the substrate inserting portion 6u having a narrow width is formed, a pair of flange portions 6t is formed at side edges of the front surface 6a of the substrate inserting portion 6u in order to sufficiently secure the area of the front surface 6a.

Contact housing grooves 8b are formed in inner wall side surfaces 8a of the coupling chamber 8. Further, a pair of fixing grooves 6g is formed at an upper end portion of the back surface 6b of the housing 6 (also see FIG. 4).

### (Shell 7)

As shown in FIG. 8, the metal plate 9 forming the shell 7 is mainly composed of a front wall portion 9a, an upper wall portion 9b, a pair of first side wall portions 9c, and a pair of second side wall portions 9d. In FIG. 8, alternate long and short dash lines indicate folded portions.

With cross reference to FIGS. 3, 5, 6, and 8, it can be seen that the front wall portion 9a covers the front surface 6a of the housing 6. As shown in FIG. 8, the front wall portion 9a includes a coupling hole 9e corresponding to the outline shape of the coupling chamber 8 (see FIG. 5), and a pair of ground contacts 9f for grounding an external shield of the modular plug 4. As shown in FIG. 3, the ground contacts 9f are folded to the inside of the coupling chamber 8 and are partially housed in the respective contact housing grooves 8b.

With cross reference to FIGS. 3, 5, 6, and 8, it can be seen that the upper wall portion 9b is folded at a substantially right angle to the top surface 6c from the front surface 6a of the housing 6, and covers the top surface 6c of the housing 6.

With cross reference to FIGS. 3, 5, 6, and 8, it can be seen that the first side wall portions 9c are respectively folded at a substantially right angle to the right-side surface 6e and the left-side surface 6f from the front surface 6a of the housing 6. Similarly, the second side wall portions 9d are respectively folded at a substantially right angle to the right-side surface 6e and the left-side surface 6f from the top surface 6c of the housing 6. Further, as shown in FIGS. 3 and 5, the right-side surface 6e and the left-side surface 6f of the housing 6 are covered by the shell 7 with no gap therebetween due to the presence of the first side wall portions 9c and the second side wall portions 9d. Specifically, as shown in FIGS. 3, 5, and 6, the first side wall portions 9c cover a half portion near the front surface 6a of each of the right-side surface 6e and the left-side surface 6f of the housing 6, and the second side wall portions 9d cover a half portion near the back surface 6b of each of the right-side surface 6e and the left-side surface 6f of the housing 6. As shown in FIGS. 3 and 4, the first side wall portions 9c and the second side wall portions 9d do not overlap each other.

The metal plate 9 shown in FIG. 8 further includes a pair of first soldered terminal portions 9g and a pair of second soldered terminal portions 9h. The first soldered terminal portions 9g are formed to extend downward in the plane of FIG. 8 from the respective first side wall portions 9c. That is, as shown in FIG. 1, the first soldered terminal portions 9g are formed to extend toward the substrate 2 from the respective first side wall portions 9c, and penetrate through the respective fixing holes 2c. Further, as shown in FIG. 8, the second soldered terminal portions 9h are formed to extend in the horizontal direction in the plane of FIG. 8 from the respective second side wall portions 9d. That is, as shown in FIG. 1, the second soldered terminal portions 9h are formed to extend toward the substrate 2 from the respective second side wall portions 9d, and penetrate through the respective fixing holes 2c. In this embodiment, as shown in FIG. 3, each soldered terminal portion 7a of the shell 7 is formed of the first soldered terminal portion 9g and the second soldered terminal portion 9h. As shown in FIG. 1, the first soldered terminal portion 9g and the second soldered terminal portion 9h are soldered to the substrate 2 through the copper foils 2d in the state of being inserted into the respective fixing holes 2c of the substrate 2.

As shown in FIG. 8, first claw portions 9i are formed in the vicinity of the second soldered terminal portions 9h. As shown in FIGS. 4 and 6, each of the first claw portions 9i is folded to the inside.

As shown in FIG. 8, a pair of second claw portions 9j is formed on the opposite side of the front wall portion 9a with the upper wall portion 9b interposed therebetween. As shown in FIGS. 4 and 6, each of the second claw portions 9j is folded to the inside and housed in the corresponding fixing groove 6g (see FIG. 4) of the housing 6.

As shown in FIG. 8, a third claw portion 9k is formed on the opposite side of the upper wall portion 9b with the front wall portion 9a interposed therebetween. The third claw portion 9k is folded to the inside as shown in FIGS. 3 and 6.

The first claw portions 9i, the second claw portions 9j, and the third claw portion 9k allow the shell 7 to be fixed to the housing 6, and effectively suppress floating of the shell 7 from the housing 6.

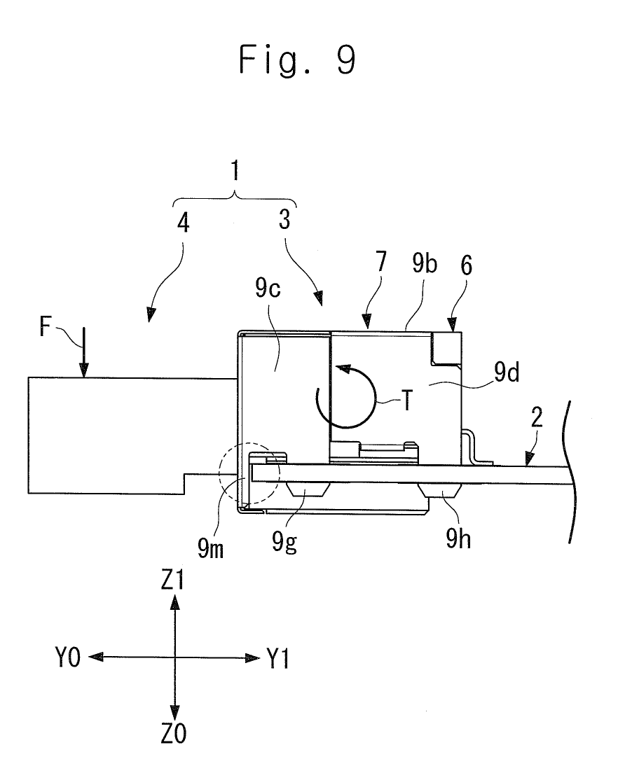

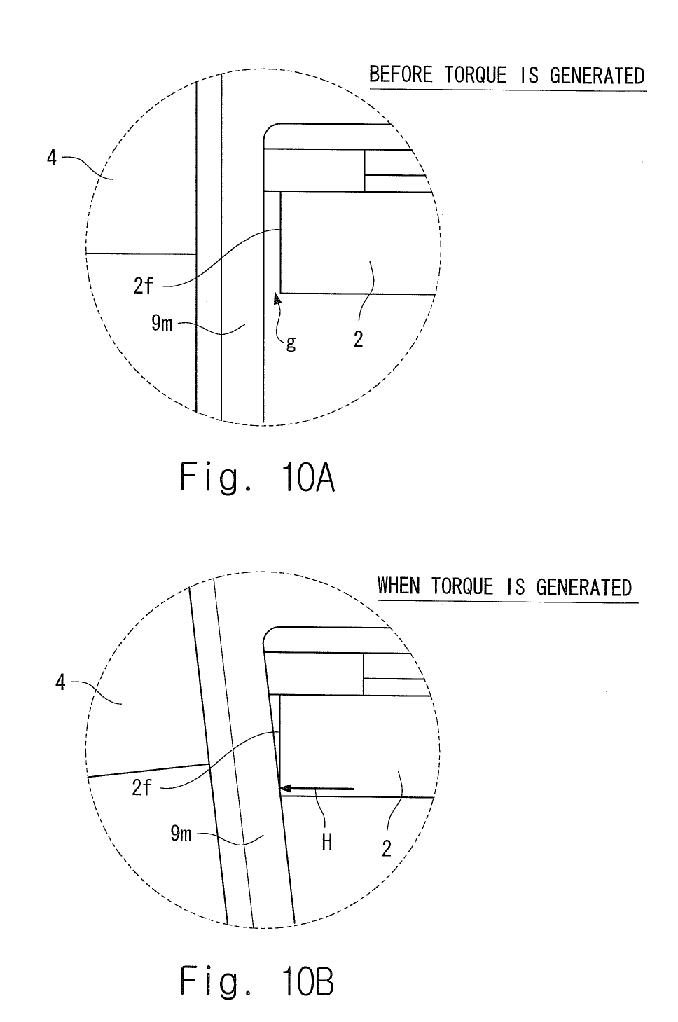

As shown in FIG. 8, abutting portions 9m are formed in the vicinity of the first side wall portions 9c. As with the first side wall portions 9c, the abutting portions 9m are respectively folded to the right-side surface 6e and the left-side surface 6f from the front surface 6a of the housing 6, as shown in FIGS. 3 and 6. When the modular jack 3 is mounted on the substrate 2 in this structure, a gap g of about 1 mm, for example, is formed between each abutting portion 9m and an end face 2f of the substrate 2 as shown in FIG. 2. In other words, each of the abutting portions 9m is formed in a shape that is extremely close to the end face 2f of the substrate 2 when the modular jack 3 is mounted on the substrate 2. The functional roles of the abutting portions 9m will be described with reference to FIG. 9 and FIGS. 10A and 10B. Referring first to FIG. 9, assume that the modular plug 4 is pressed and twisted downward in the plane of FIG. 9 with a strong force F. Then, a torque T acting counterclockwise in the plane of FIG. 9 occurs in the modular connector 1. This torque T acts to keep the second side wall portions 9d away from the substrate 2. On the other hand, since the second soldered terminal portions 9h are soldered to the respective fixing holes 2c, the second soldered terminal portions 9h act to prevent the second side wall portions 9d from being kept away from the substrate 2. Further, since the second soldered terminal portions 9h are formed to be folded from the upper wall portion 9b through the second side wall portions 9d, the strength in the direction in which the upper wall portion 9b and the second side wall portions 9d are opened when they are pressed with the force F shown in FIG. 9 is strong, which improves the strength of the modular connector 1 with respect to the substrate 2.

At this time, the shell 7 shown in FIG. 9 is slightly deformed counterclockwise in the plane of FIG. 9, and the gap g between each abutting portion 9m and the end face 2f of the substrate 2 shown in FIG. 10A before the generation of the torque disappears as shown in FIG. 10B when the torque is generated. At the same time, the abutting portion 9m abuts and contacts the end face 2f of the substrate 2. Such a physical contact generates a reaction force H (see FIG. 10B) that is cancelled out by a part of the torque T shown in FIG. 9. Accordingly, the presence of the abutting portions 9m enables reduction in the load on the second soldered terminal portions 9h when the modular plug 4 is pressed and twisted with the strong force F as shown in FIG. 9.

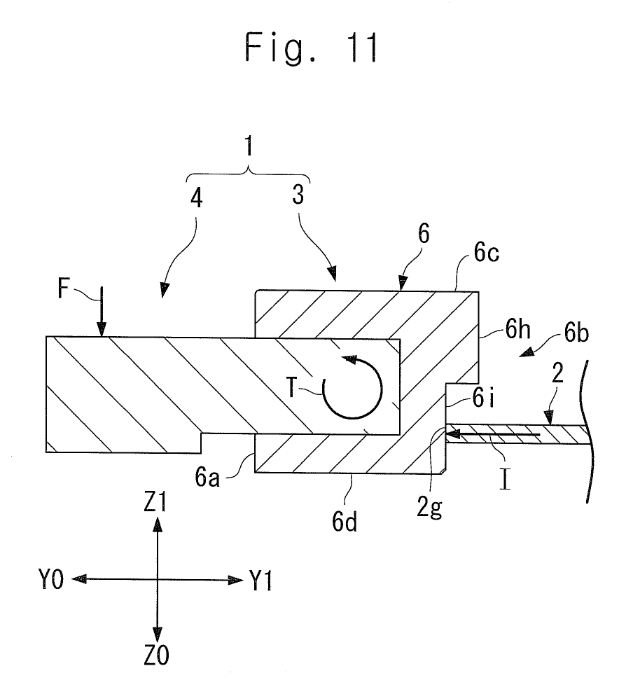

FIG. 11 schematically shows the modular plug 4, the housing 6 of the modular jack 3, and the substrate 2. As shown in FIG. 11, the back surface 6b of the housing 6 in this embodiment is formed to be able to abut an end face 2g of the substrate 2 when the above-mentioned torque T acts on the housing 6. Specifically, the back surface 6b of the housing 6 includes a first back surface 6h near the top surface 6c, and a second back surface 6i near the bottom surface 6b. Of these back surfaces, the second back surface 6i is formed to contact the end face 2g of the substrate 2 in the state of FIG. 11 in which the modular jack 3 is mounted on the substrate 2. Accordingly, when the above-mentioned torque T acts on the housing 6, the second back surface 6i of the back surface 6b of the housing 6 is allowed to contact the end face 2g of the substrate 2 with a strong pressure, so that the second back surface 6i receives a reaction force I, which is a reaction force against the contact, from the end face 2g of the substrate 2. The reaction force I is cancelled out by a part of the above-mentioned torque T. Accordingly, the presence of the second back surface 6i enables reduction in the load on the second soldered terminal portions 9h (see FIG. 9) when the modular plug 4 is pressed and twisted with the strong force F as shown in FIG. 11.

### SUMMARY

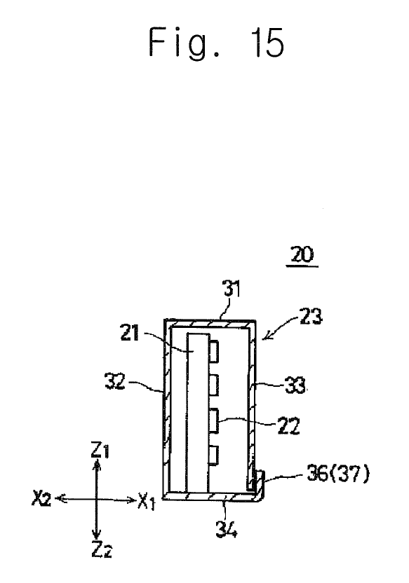

(1) In the embodiments as described above, the modular jack 3 has the following structure. That is, as shown in FIG. 3, the shell 7 includes the soldered terminal portion 7a to be connected to the substrate 2. The soldered terminal portion 7a includes the first soldered terminal portion 9g and the second soldered terminal portion 9h. As shown in FIGS. 3 and 5, the first soldered terminal portions 9g are formed to extend toward the substrate 2 (see FIG. 1) from the first side wall portions 9c which are respectively folded to the right-side surface 6e and the left-side surface 6f from the front surface 6a of the housing 6. As shown in FIGS. 3 and 5, the second soldered terminal portions 9h are formed to extend toward the substrate 2 (see FIG. 1) from the second side wall portions 9d which are respectively folded to the right-side surface 6e and the left-side surface 6f of the housing 6 from the upper wall portion 9b which is folded to the top surface 6c from the front surface 6a of the housing 6. Further, as shown in FIGS. 3 and 5, the first side wall portions 9c and the second side wall portions 9d cover the right-side surface 6e and the left-side surface 6f of the housing 6. That is, as shown in FIG. 15, as is obvious from the positional relationship between reference numeral 36 (37) and reference numeral 33, the metal plate shell 23 of the USB connector 20 disclosed in Cited Literature 1 has an overlapping portion. On the other hand, according to the structure described above, there is no overlapping portion that overlaps the shell 7 as shown in FIG. 3, thereby suppressing the total area of the metal plate 9 (see FIG. 8) which is the material of the shell 7. Therefore, it is possible to provide the modular jack 3 that achieves suppression of material cost.

As shown in FIG. 1, the modular jack 3 is mounted on the substrate 2 at two positions on one side, thereby achieving strong fixation of the modular jack 3 to the substrate 2.

(2) Further, as shown in FIG. 9 and FIGS. 10A and 10B, the shell 7 includes the abutting portions 9m which are formed to be able to abut the substrate 2 when the torque T which keeps the second side wall portions 9d away from the substrate 2 acts on the housing 6. Thus, the employment of the structure in which the abutting portions 9m are formed to abut the substrate 2 when the torque T is generated allows cancellation of a part of the torque T. Since a part of the torque T is cancelled, the load on the second soldered terminal portions 9h which prevents the second side wall portions 9d from being kept away from the substrate 2 can be alleviated.

(3) Furthermore, as shown in FIG. 11, the housing 6 is formed to be able to abut the substrate 2 when the torque T which keeps the second side wall portions 9d (see FIG. 9) away from the substrate 2 acts on the housing 6. Thus, the employment of the structure in which the housing 6 is formed to be able to abut the substrate 2 when the torque T is generated allows cancellation of a part of the torque T. Since a part of the torque T is cancelled, the load on the second soldered terminal portions 9h which prevents the second side wall portions 9d from being kept away from the substrate 2 can be alleviated.

### Second Embodiment

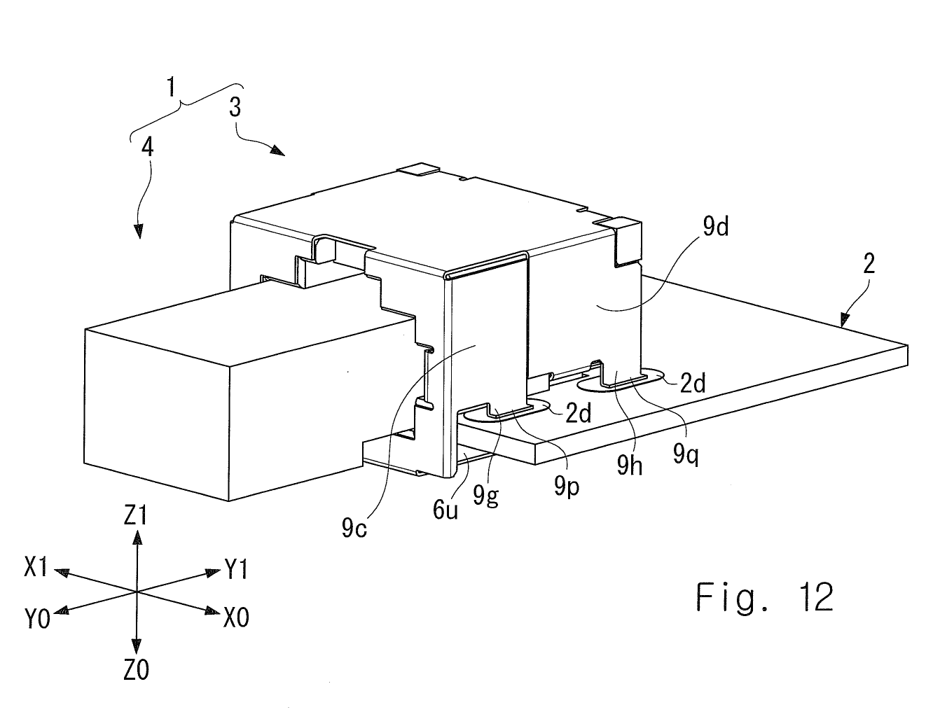

Referring next to FIG. 12, the modular jack 3 according to a second embodiment of the present invention will be described. Hereinafter, differences between this embodiment and the first embodiment are mainly described, and a repeated explanation is omitted as needed. Further, the components corresponding to those described in the first embodiment are denoted by the same reference numerals as a general rule.

As shown in FIG. 1, in the first embodiment described above, the soldered portions to be soldered to the substrate 2, that is, the first soldered terminal portions 9g and the second soldered terminal portions 9h, are formed to extend from the first side wall portions 9c and the second side wall portions 9d so as to penetrate through the respective fixing holes 2c of the substrate 2. On the other hand, as shown in FIG. 12, in this embodiment, the fixing holes 2c are not formed in the substrate 2. Accordingly, soldered portions 9p are formed by folding a lower end portion of each of the first soldered terminal portions 9g at a substantially right angle to the outside so as to be in parallel with the substrate 2, and soldered portions 9q are formed by folding a lower end portion of each of the second soldered terminal portions 9h at a substantially right angle to the outside so as to be in parallel with the substrate 2. The soldered portions 9p and the soldered portions 9q are soldered to the respective copper foils 2d of the substrate 2. Note that the first soldered terminal portions 9g and the second soldered terminal portions 9h in this embodiment are also formed to extend toward the substrate 2 from the first side wall portions 9c and the second side wall portions 9d, as with the first embodiment.

### Third Embodiment

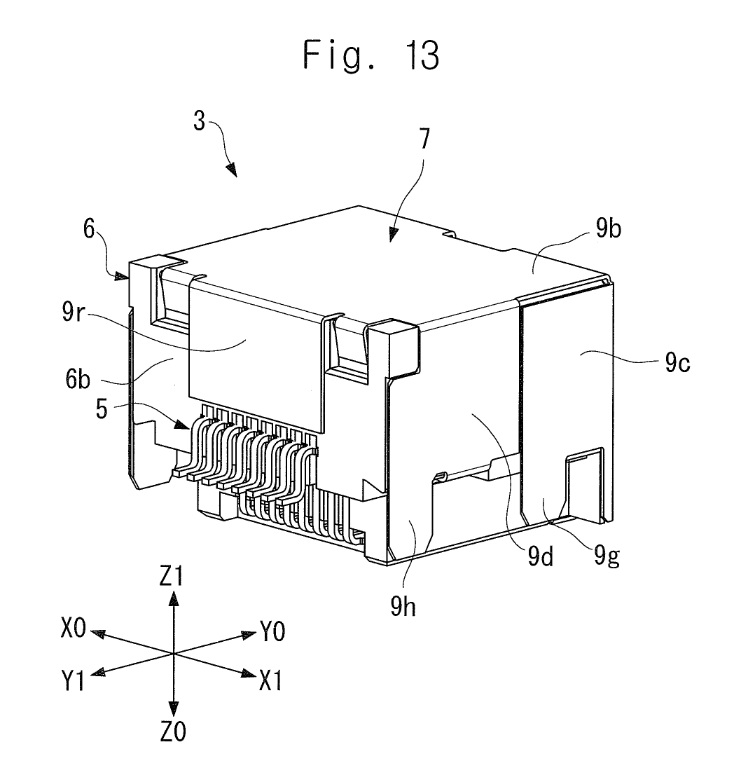

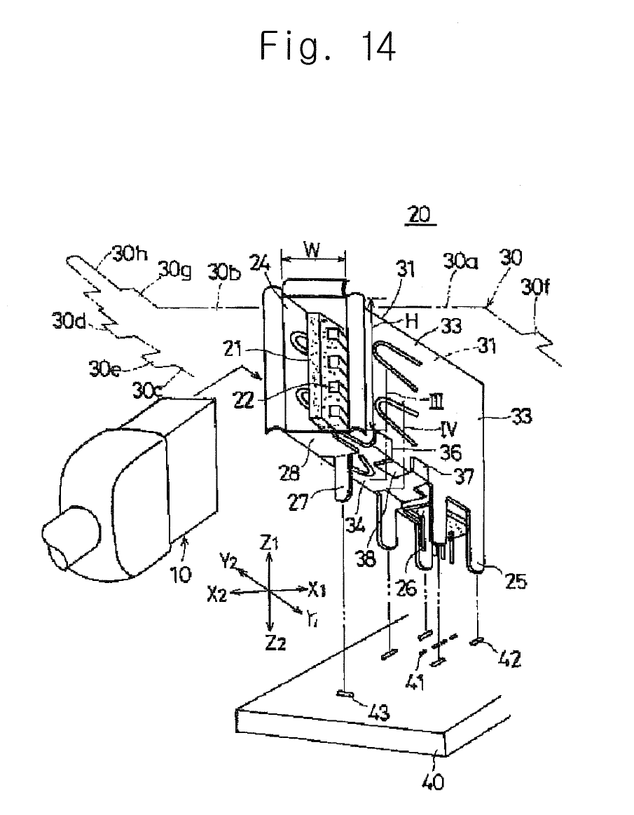

Referring next to FIG. 13, the modular jack 3 according to a third embodiment of the present invention will be described. Hereinafter, differences between this embodiment and the first embodiment are mainly described, and a repeated description is omitted as needed. The components corresponding to those described in the first embodiment are denoted by the same reference numerals as a general rule.

As shown in FIGS. 1 and 3, the shell 7 in this embodiment includes a back wall portion 9r which partially covers the back surface 6b of the housing 6. This back wall portion 9r is formed to be folded toward the back surface 6b of the housing 6 shown in FIG. 13 from the top surface 6c of the housing 6 shown in FIG. 5. Due to the presence of the back wall portion 9r, a wider range of the housing 6 is covered by the shell 7, compared with the first embodiment shown in FIG. 4, thereby enabling the shell 7 to more effectively exert the effect as countermeasures against the EMI.

While preferred embodiments of the present invention have been described above, the embodiments may be appropriately combined with each other.

### REFERENCE SIGNS LIST

1 MODULAR CONNECTOR
2 SUBSTRATE
3 MODULAR JACK (CONNECTOR)
4 MODULAR PLUG (COUNTERPART CONNECTOR)
5 CONTACT
6 HOUSING
6a FRONT SURFACE
6b BACK SURFACE
6c TOP SURFACE
6d BOTTOM SURFACE
6e RIGHT-SIDE SURFACE
6f LEFT-SIDE SURFACE
7 SHELL
7a SOLDERED TERMINAL PORTION
8 COUPLING CHAMBER
9 METAL PLATE
9a FRONT WALL PORTION
9b UPPER WALL PORTION
9c FIRST SIDE WALL PORTION
9d SECOND SIDE WALL PORTION
9e COUPLING HOLE
9f GROUND CONTACT
9g FIRST SOLDERED TERMINAL PORTION
9h SECOND SOLDERED TERMINAL PORTION
9m ABUTTING PORTION
9r BACK WALL PORTION
T TORQUE

1. A connector of a right angle type used to be mounted on a substrate, the connector comprising:
a contact;
a housing that holds the contact; and
a shell that covers the housing, wherein
the shell includes a soldered terminal portion connected to the substrate,
the soldered terminal portion includes a first soldered terminal portion and a second soldered terminal portion,
the first soldered terminal portion is formed to extend toward the substrate from a first side wall portion folded from a front surface of the housing toward a side surface of the housing, the housing having a coupling hole into which a counterpart connector is inserted,
the second soldered terminal portion is formed to extend toward the substrate from a second side wall portion folded from an upper wall portion toward the side surface of the housing, the upper wall portion being folded from the front surface of the housing toward a top surface of the housing, and
the first side wall portion and the second side wall portion cover the side surface of the housing.

2. The connector according to claim 1, wherein
the shell includes:
a front wall portion provided on the front surface of the housing; and
an abutting portion formed to be able to abut the substrate when a torque that keeps the second side wall portion away from the substrate acts on the housing.

3. The connector according to claim 2, wherein the abutting portion is formed to be folded from the front surface of the housing toward the side surface.

4. The connector according to claim 1, wherein the housing is formed to be able to abut the substrate when a torque that keeps the second side wall portion away from the substrate acts on the housing.

5. The connector according to claim 4, wherein a back surface of the housing is formed to be able to abut the substrate when a torque that keeps the second side wall portion away from the substrate acts on the housing.
